(19) United States
(12) Patent Application Publication
(10) Pub. No.: US 2012/0232927 A1
(43) Pub. Date: Sep. 13, 2012

(54) SYSTEM FOR THE CONTROL AND INTEGRAL MANAGEMENT OF THE MEDICAL RECORDS OF PATIENTS IN HEALTH CARE CENTRES, HOSPITALS, OUTPATIENT CENTERS AND THE GENERAL HEALTHCARE SYSTEM

(75) Inventor: Javier Vinals Larruga, Madrid (ES)

(73) Assignee: EMR, LLC d/b/a MediBank International, Dallas, TX (US)

(21) Appl. No.: 13/394,810

(22) PCT Filed: Sep. 7, 2009
(86) PCT No.: PCT/ES2009/000441

§ 371 Date: Mar. 7, 2012

(51) Int. Cl. G06Q 50/24

(52) U.S. Cl. 705/3

(57) ABSTRACT

SYSTEM FOR CONTROL AND MANAGEMENT OF PATIENT MEDICAL RECORDS IN HEALTH CENTERS, HOSPITAL, MEDICAL CARE CENTERS AND WITHIN THE GENERAL HEALTH SYSTEM AS A WHOLE which essentially consists of a monitoring operation and management of the CAC system (Continuum Assisted Care) and resolution of incidents in the flow of information between doctors and patients, that is based on the rapid creation and easy access to disease monitoring protocols. This is a private relationship between doctor and patient that is automated and simplified through the proprietary CAC Platform System and can not be characterized in any case as a medical act. The services are related to the CAC process support, oversee and monitor the correct flow of information to be produced once the monitoring and control relationship between doctors and patients is established, whose order of performance is:
Regular review of all protocols or templates that are activated in a given period of time.
Introduction on the monitoring system of the patterns and intervals scheduled by the doctor.
Automatic check for compliance by the patient to the frequency indicated.
In cases in which a lack of reception of data is detected, a call center is brought into contact with the user as the first phase.
If the patient wishes to leave the monitoring, reporting to the doctor and the protocol is aborted.
In the case of an error or a problem of logistics, it supports the user and provides the necessary support so that the required information is finally gathered. Additionally, the doctor sends a report on the operation control system to facilitate data flow, informing that the case is not an abandonment by the patient. In the latter case, the patient is reclassified to perform a more intense monitoring future.

### OBJECT OF THE INVENTION

As the title of the invention sets forth, the invention comprises a computer control system and integrated management of clinical records and medical care activities of patients in health centers, hospitals, clinics and particularly in any national and international health network. Doctors, practitioners, specialists or others are able to interact, update, maintain or correct the data related to health care activity for patients, and they also can interact with the patient himself, for which the system incorporates all the necessary tools to ensure the success of the use of the program, hereinafter called the “system”.

### BACKGROUND OF THE INVENTION

The usual environment uses local software tools at the basic premises of each medical center and is limited to each specialty in order to learn about the history of a patient. The patient usually belongs to the center, having a single record to store the chronological development of the medical life of the patient related to that center and the particular physician assigned to him, whether nursing, family doctor, specialist or another.

### DESCRIPTION OF THE INVENTION

The invention is divided in the following fields:

1.—System comprising the following operations:

1.1.—Data input via WEB.

1.2.—Data Entry by secure fax. (attached drawings)

1.3.—Data entry via CONNECTIVITY (Id.)

2.—System comprising the following operations:

2.0—About the Representation of History of Health.

2.1—About the Information Extraction via Web—full report.

2.2—About the Web-based Information Extraction—Specific extraction method.

2.3—About the Information Extraction via Web—Report description interface.

3.—System comprising the following operations:

3.1—Health Journal—summary screen.

3.2—Health Journal—screen.

4.—System comprising the following operations:

4.1—General Prevention.

4.2—Profiling Prevention

5.—System comprising the following operations:

5.1—Information Extraction EMERGENCY PIN.

5.2—CONTINUUM ASSISTED CARE (CAC) (1).

5.3—CONTINUUM ASSISTED CARE (CAC) (2).

5.4—CONTINUUM ASSISTED CARE (CAC) (3).

5.5—CONTINUUM ASSISTED CARE (CAC) (4).

6.—System comprising the following operations:

6.1—About systems integration.—

6.2—About ADAPTATION, EMBEDDED and mimicry.

6.3—About PROFESSIONAL.

6.4—About PROFESSIONAL (1).

6.5—About PROFESSIONAL (2).

6.6—About PROFESSIONAL (3).

6.7—About C.A.C. Web to schedule protocols.

6.8—About Web Hosting and Connectivity.

6.9—About Technical Maintenance and Technical Support.

6.10. About Monitoring of Management and Connectivity correct data from health information systems.

7.—System comprising the following operations:

7.1—About scheduled phone anamnesis.

7.2—About proactive recovery and Medical Reports Flow Monitoring.

7.3—About Classification of Types of Reports and ICD coding.

7.4—About Medical Support Call Center to incidents with the introduction or extraction of information.

7.5—About Monitoring and system management and troubleshooting C.A.C. in the flow of information between doctors and patients.

1.1.—An operation which comprises data introduction via web and a screen allowing the user to access a form where he can select a file for uploading (scanned clinical report) to be added to the personal database. Supported format files comprising:
JPEG.
GIF.
TIFF.
BMP.
PDF.

Additionally, it allows the user to enter certain information associated with the document that is downloaded to the server:
Date of report.
Physician-author.
Specialty.
Center of Origin.
Type of report.

All this information is tagged within the database system as NOT VERIFIED from the medical standpoint. Later, as part of another procedure, there is a possibility of further medical examination and ICD coding by a licensed physician.

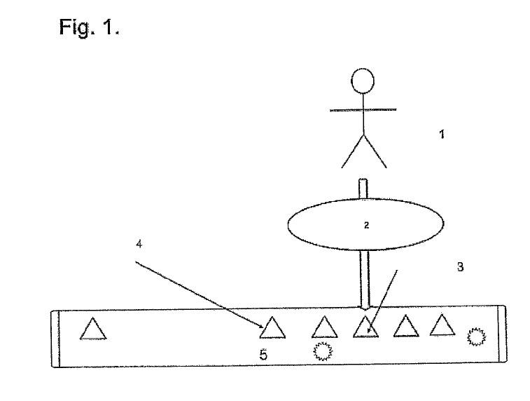

1.2.—An operation that consists of the introduction of data via secure fax (see block diagram in FIG. 1 p.), In which the user has a unique identification code and a single fax number composed of made of the initials 9 numbers of the header plus an individual code assigned. By simply dialing the complete code, the faxed document is automatically deposited in the personal database of medical reports of the user.

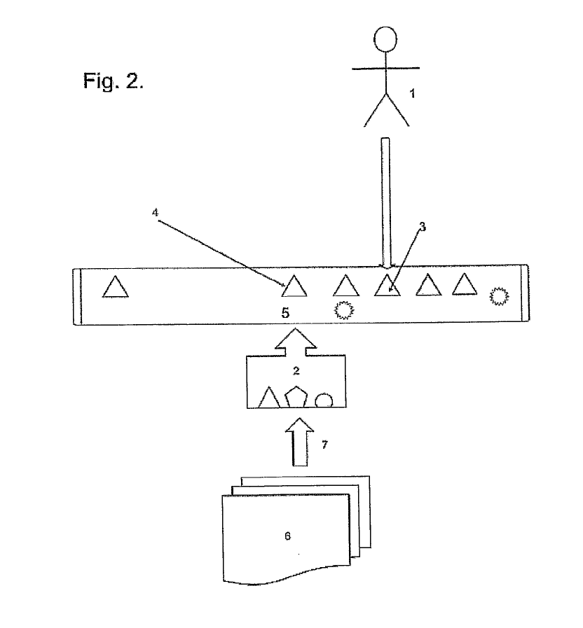

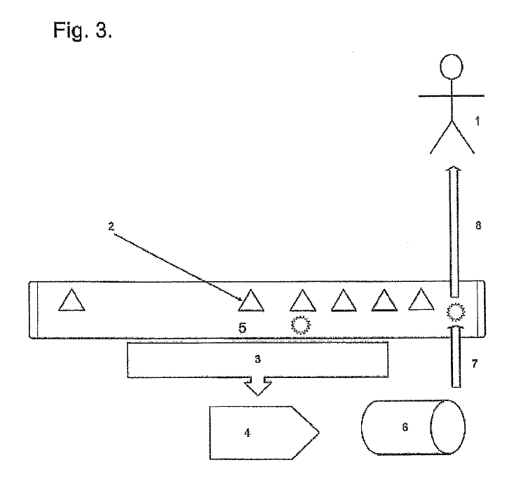

1.3.—An operation that consists of data entry via CONNECTIVITY (see block diagram in FIG. 2 p.), which have connecting links or direct connectivity links to the system, depositing a copy directly on the central database system. To do this, there is a definite relationship between the identifier from the original information system (usually a H.I.S. or Hospital Information System) and the unique system user identifier. Also, all necessary fields that form part of the set of information that will be available to the user through the system and therefore be transferred with their consent from one system to another, are previously defined.

2.0—An operation that consists of checking the owner's representative Health Record (see diagram FIG. 3 Page . . . ) that allows the user to have a quick and accurate picture of his medical profile at a glance. The purpose of the diagram is to represent a time-scale axis placing the in other axis the columns that symbolize the different medical areas that for the different medical specialties (cardiology, orthopedics, neurology, etc.). The peculiarity that allows this operation to provide as much important information in so little space lies not only in their spatial organization, but the icons and symbols that represent each report. These comprise the following elements:
3 letter-acronym: defines the type of report (LAB=Laboratory, RAX=Radiology X-Ray, MRI=magnetic resonance imaging).
Exact date.

Additionally, the diagram clearly visible groups of reports that are part of a single clinical episode. For example, in the case of an intervention emergency surgery, a clinical event could consist of the following individual reports:
Emergency report.
Lab Report.
Preanesthetic preparation report.
Surgery report.
Treatment continuity report.
Discharge Report.

2.1—An operation that consists of Web-based Information Capturing—full report consists of two options:

A: Capturing the full report.

B: Specific capture and report search.

The user has an interface that allows to select:
Range of insertion dates for the search (start/end).
Range of creation dates for the search (start/end).
Medical specialities.
Center of Origin.
Type of report.
Medical/Editor of the Report.
ICD code.

Also, the interface allows the user to filter the search results according to the level of privacy (visible or not visible) that the user assigned to each report.

The system provides a sorted and classified list that allows users to interact, allowing a mouse selection of the information to be viewed. Once selected, the user accesses a screen that lets the user see the basic areas of the report:
Encoded information.
Text of the report.
Pictures or attachments.

2.2—An operation that consists of web-based information capture—specific capture. which consists of two options:

A: Capturing the full report.

B: Specific capture and and report search.

The user has an interface that allows to select:
Range of insertion dates for the search (start/end).
Range of creation dates for the search (start/end).
Medical specialities.
Center of Origin.
Type of report.
Medical/Editor of the Report.
ICD code.

Also, the interface allows the user to filter the search results according to the level of privacy (visible or not visible) that the user assigned to each report.

The system provides a sorted and classified list that allows users to interact, allowing a mouse selection of the information to be viewed. Once selected, the user accesses a screen that lets the user see the basic areas of the report:
Encoded information.
Text of the report.
Pictures or attachments.

2.3—An operation that consists of Web-based Information Extraction—descriptive report interface with two options:

A: Capturing the full report.

B: Specific capture and and report search.

The user has an interface that allows to select:
Range of insertion dates for the search (start/end).
Range of creation dates for the search (start/end).
Medical specialities.
Center of Origin.
Type of report.
Medical/Editor of the Report.
ICD code.

Also, the interface allows the user to filter the search results according to the level of privacy (visible or not visible) that the user assigned to each report.

The system provides a sorted and classified list that allows users to interact, allowing a mouse selection of the information to be viewed. Once selected, the user accesses a screen that lets the user see the basic areas of the report:
Encoded information.
Text of the report.
Pictures or attachments.

3.1—An operation that consists in verifying the Journal of Health-Summary screen is composed of a double option:
Summary screen.—Allows the user from the home page of global information gathering your data, go to:
   Personal health summary system. Expresses the overall quality of life for users and presents a detailed explanation based on data from the same over time. In turn windows are disclosed in specific for:
      Weight control.
      Control Habits of Healthy Living.
      Control Diet.
      Control of Exercise.
   Personal calendar. Allows user to set appointments and reminders on the dates you want. These quotes can be associated alarms are sent to you via email or the mobile phone with SMS gateway technology.
Home Screen. Provides access to more accurate and tracking tables for each of the basic parameters. It also contains a form where the user can update, with the frequency he desires, the basic data about personal health status.

3.2—An operation that consists in verifying the Journal of Health-Summary screen is composed of a double option:
Summary screen.—Allows the user from the home page of global information gathering your data, go to:
   Personal health summary system. Expresses the overall quality of life for users and presents a detailed explanation based on data from the same over time. In turn windows are disclosed in specific for:
      Weight control.
      Control Habits of Healthy Living.
      Control Diet.
      Control of Exercise.
   Personal calendar. Allows user to set appointments and reminders on the dates you want. These quotes can be associated alarms are sent to you via email or the mobile phone with SMS gateway technology.
Home Screen. Provides access to more accurate and tracking tables for each of the basic parameters. It also contains a form where the user can update, with the frequency he desires, the basic data about personal health status.

4.1—A General Prevention operation. These are processes that inform the user about any prevention protocol to be published both by the World Health Organization and by the Ministry of Health, Consensus or groups.

The information is not filtered but reaches the user as delivered by the origin or source.

The system upgrades and renewals constantly based on seasonal changes.

In general, these protocols affect the population as a whole, so they tend to be broad-based. In this way, users of the system are no longer required to be alert to the different sources where these campaigns are usually published, and they just simply access from their personal page of medical information having the security of never missing relevant information.

There are two areas:
Summary window in the custom page of the user.
Detailed explanation windows (higher or lower depending on the content of the protocol in question).

4.2—A profile-dependant prevention. These are processes that inform the user about any prevention protocol to be published both by the World Health Organization and by the Ministry of Health, Consensus or groups.

In this case the information is filtered and intersects with the data that the system contains about the patient, primarily data relating to:
Age.
Sex.
Weight.
Smoking-habits.
Drug-habits.
Stress.
Dietary habits.
Personal History.
Family History.

With these premises, an additional prevention can be done with a high degree of sophistication and specificity, oriented such that user need not to go to the doctor's office to find out if he should be included in certain risk groups.

The operation also includes:
A summary screen which shows the results of cross-checking with database of all potential prevention protocols for all risk groups.
A specific discussion screen of each particular protocol with the possibility of a personalized and self-control.

5.1—An operation consisting of Information Extraction via EMERGENCY PIN. All users, when registering in the system, also receive along with the name and password, a special number called EMERGENCY PIN. By using this Pin (either through the process described by web or by phone), the user obtains immediately the complete medical file contained in the system, sent to the desired address (email, fax, or print directly via the web).

Once used, the system disables the Emergency PIN and generates a new one that is sent to the user. The purpose of this procedure is to disable the possibility of recurrent inputs to the system through unauthorized use.

5.2—An operation that consists in verifying the CONTINUUM ASSISTED CARE (CAC) (1) in which the owner of the system to process CONTINUUM ASSISTED CARE (CAC) has 2 major components:

A) The individualized pattern operation via web (for doctors). It is a secure web-accessible way that allows the physician to select a specific patient and establish a simple custom protocol. In addition to setting the parameters to be controlled, can make both the frequency and mode of delivery and collection. The fields that the system provides are:

A) Name of the protocol (can be saved commonly used protocols or standard):
B) Name of the parameter.
C) Maximum value evaluable.
D) Minimum evaluable.
E) monitoring mode (receive mode of information).
F) common monitoring option.

B) The patient review system, both as detailed or aggregated review of patient data.

Medical users can access a web system that allows:

A) Check with an overview of health status, trends and observations of patients in follow-up.

B) Review in depth the evolution of part of a particular patient.

Users simply receive an SMS message, email or a phone call which should include the value for each of the patterned fields.

The doctors always have the ability to perform a “phone consultation” with the patient if they notice significant deviations in their graphs of monitoring. The operation is aimed at preventing the continued assistance of the patient to the doctor for review, as well as to prevent unnecessary admissions to emergency room due to lack of monitoring.

5.3—A verify operation CONTINUUM ASSISTED CARE (CAC) (2) in which the owner of the system to process CONTINUUM ASSISTED CARE (CAC) has two major components:

A) The individualized pattern operation via web (for doctors). It is a secure web-accessible way that allows the physician to select a specific patient and establish a simple custom protocol. In addition to setting the parameters to be controlled, can make both the frequency and mode of delivery and collection. The fields that the system provides are:

A) Name of the protocol (can be saved commonly used protocols or standard):
B) Name of the parameter.
C) Maximum value evaluable.
D) Minimum evaluable.
E) monitoring mode (receive mode of information).
F) common monitoring option.

B) The patient review system, both as detailed or aggregated review of patient data.

Medical users can access a web system that allows:

A) Check with an overview of health status, trends and observations of patients in follow-up.

B) Review in depth the evolution of part of a particular patient.

Users simply receive an SMS message, email or a phone call which should include the value for each of the patterned fields.

The doctors always have the ability to perform a “phone consultation” with the patient if they notice significant deviations in their graphs of monitoring. The operation is aimed at preventing the continued assistance of the patient to the doctor for review, as well as to prevent unnecessary admissions to emergency room due to lack of monitoring.

5.4—A verify operation CONTINUUM ASSISTED CARE (CAC) (2) in which the owner of the system to process CONTINUUM ASSISTED CARE (CAC) has two major components:

A) The individualized pattern operation via web (for doctors). It is a secure web-accessible way that allows the physician to select a specific patient and establish a simple custom protocol. In addition to setting the parameters to be controlled, can make both the frequency and mode of delivery and collection. The fields that the system provides are:

A) Name of the protocol (can be saved commonly used protocols or standard):
B) Name of the parameter.
C) Maximum value evaluable.
D) Minimum evaluable.
E) monitoring mode (receive mode of information).
F) common monitoring option.

B) The patient review system, both as detailed or aggregated review of patient data.

Medical users can access a web system that allows:

A) Check with an overview of health status, trends and observations of patients in follow-up.

B) Review in depth the evolution of part of a particular patient.

Users simply receive an SMS message, email or a phone call which should include the value for each of the patterned fields.

The doctors always have the ability to perform a “phone consultation” with the patient if they notice significant deviations in their graphs of monitoring. The operation is aimed at preventing the continued assistance of the patient to the doctor for review, as well as to prevent unnecessary admissions to emergency room due to lack of monitoring.

5.5—A verify operation CONTINUUM ASSISTED CARE (CAC) (2) in which the owner of the system to process CONTINUUM ASSISTED CARE (CAC) has two major components:

A) The individualized pattern operation via web (for doctors). It is a secure web-accessible way that allows the physician to select a specific patient and establish a simple custom protocol. In addition to setting the parameters to be controlled, can make both the frequency and mode of delivery and collection. The fields that the system provides are:

A) Name of the protocol (can be saved commonly used protocols or standard):
B) Name of the parameter.
C) Maximum value evaluable.
D) Minimum evaluable.
E) monitoring mode (receive mode of information).
F) common monitoring option.

B) The patient review system, both as detailed or aggregated review of patient data.

Medical users can access a web system that allows:

A) Check with an overview of health status, trends and observations of patients in follow-up.

B) Review in depth the evolution of part of a particular patient.

Users simply receive an SMS message, email or a phone call which should include the value for each of the patterned fields.

The doctors always have the ability to perform a “phone consultation” with the patient if they notice significant deviations in their graphs of monitoring. The operation is aimed at preventing the continued assistance of the patient to the doctor for review, as well as to prevent unnecessary admissions to emergency room due to lack of monitoring.

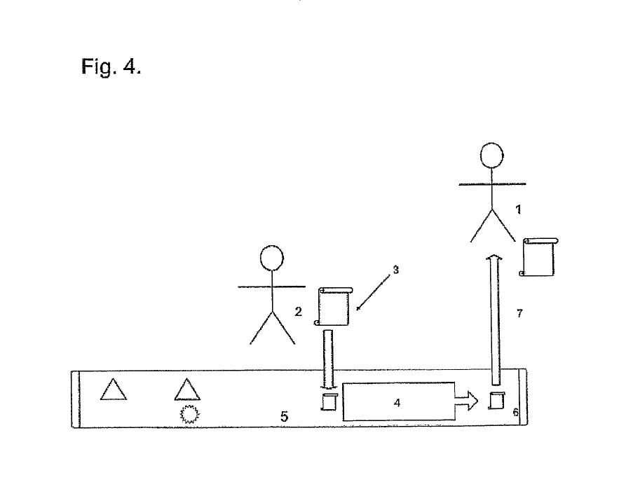

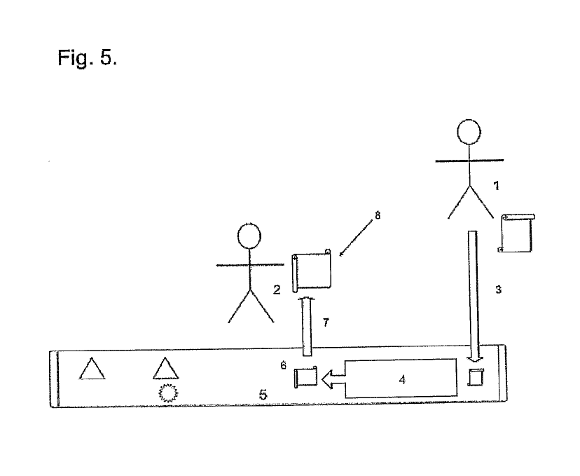

6.1—An operation of systems integration (see block diagram in FIG. 4 p) comprises the development of the operational elements that allow the integration of patient's data with any HIS (Hospital Information System), Primary Care Systems, or Clinical Record Management Systems for Clinics or other medical centers.

The product contains a precise definition of the fields to import:
Name of the Report.
Id. Patient.
Name of Patient.
Basic Personal details of the patient.
Deliverable text report.
Added files (images, etc.).
ICD code.
Internal classification and indexing code.
Medical Specialty.
Date.
Type.
Index of opening or closing episode.

Furthermore, we have developed APIs (Application Programming Interfaces) that allow basic communications of other processes fluently with the system. The system provides a complete set for the communication of the fields described above as well as a general definition for future development.

6.2—An operation of ADAPTATION, EMBEDDED and mimicry that allows the system, which evolved into interchangeable blocks of code and XML templates, for easy integration into Web sites of other institutions.

Furthermore, these templates allow rapid changes in:
Color scheme.
Outline of topics.
Font sizes and types of headers.
Relational placement schemes.

In this way the functionality of the system can be used in a different environment, providing brand image to a separate company, but using the “engine” and operating the same database system all completely transparent to the end user.

6.3—A PROFESSIONAL operation that, once entered the application, provides a window which configuration depends on the profile of our users. This document explains with more detail the type of window that can be displayed, ie the supervisor for the profile, and at the end of the document there is a reference for the different user profiles that exist and the limitations of each of them. Therefore, we proceed to explain each of pictures or frames that make up the application and the menus and the information it provides.

2.1 Information Overview.

Within the application we have the following general information:
Information from the name of the application and then the entity to which we are connected (labeled 1 in the table above)
Information on the type of profile that has our users, which will determine the operations that we perform and we can visualize the data (marked 2 in the table above).

2.2 Menus of the application.

Within the application there are three menus that we describe below.
File Menu.

Within this menu you have the options Save, General Data Change, Change Password, Database, Medicines and Exit.

Save submenu lets you record any changes we have made in managing the application data (patient, reports, etc.) At any time.

6.4—A PROFESSIONAL operation (1) in which the “Change general data” submenu allows the user to modify the general data, ie the user who is connected to the application.

Within this window one can change the Name, Last Name, Number of collegiate and Email.

Change Password submenu allows us to change our password to the application. To do this when you select this option, the user is redirected to the window:

In which we are asked the password to the current application and the new password. For change to be effective we must press the “OK”. In case you do not want to change the password, “Cancel” button must be pressed.

The submenu “Drug Database”, leads to the publications page of the Ministry of Health, from where we have access to drug consultation and active ingredients related.

The Exit submenu is used to exit the application. If we have made changes to any of the data, or have added new data, and we select this menu without having saved, the application will tell us if we want to exit and save changes or not, or if we cancel the close the application

6.5—A PROFESSIONAL operation (2) in which is used:

Tools Menu.

In this menu we have the submenu and the submenu Edit Preferences health entity.

The Preferences submenu allows access to another screen where you can configure application features. Specifically:
Location of the drug database within our system, or access to a free version of the same in the event that it is not available:

To save the changes we make must first press the “Apply” and then “OK”.
Sending Data Set configuration: set the data or parameters of the mail server and the account from which the clinic will send emails to your patients:

Also in this window, indicated by marking the appropriate boxes, the user can change the configuration of the way the clinic will send via email or sms to the key patients when accessing to the application, and whether to warn the patient via email or sms when creating a report for him in the system.

As in the previous case, to save the changes we make must first press the “Apply” and then “OK”.

Language: select the language that presents the texts and messages of the application. Currently you can choose between English, Spanish and Portuguese.

6.6—A PROFESSIONAL operation (3) that, as in previous cases, to save the changes we make must first press the “Apply” and then “OK”.
Network Connections: Modify the configuration of Internet access in the event that the clinic has a Proxy:
The options “Core” and “Global Core” are only accessible to the administrator of the application, so if you mark the box you get the following information:

The Edit health entity submenu allows us to access another screen in which we can modify our clinic's data. We may change the name, description, and add or remove insurance companies in the list.

To do this we must press the “Add Insurance Company”, which shows a list in which insurers already working with our clinic are identified, and also a list of all possible insurance companies is showed.

On this list we can check and uncheck insurers:

Once you have made your selection click on “OK” to establish an association between an insurance company and our clinic.
Menu Help.

If you select this menu you can view technical information on the application.

6.7—An operation to schedule C.A.C. Web protocols in an individualized pattern mode via web (for doctors).

The system shows a simple protocol, via secure web, allowing the physician to select a specific patient and establish a simple custom protocol. In addition to setting the parameters to be controlled, the physician can change both the frequency and the mode of delivery and collection. The fields that the system provides are:

A) Name of the protocol (can save commonly used protocols or standard).

B) Name of the parameter.

C) Maximum value evaluable.

D) Minimum evaluable.

E) monitoring mode (mode of receipt of the information).

F) common monitoring option.

6.8—A Web Hosting operation and connectivity (see FIG. 4 Page) on which the specific service as Dedicated Hosting, is so named because it uses specifically a group of servers for the exclusive use by users the system. The process contains its own operating system and applications needed to keep the entire operation, bringing besides their hosting all issues relating to the operation and physical maintenance of equipment, such as adequate space and conditioning, climate and redundant power, all installation work, wiring and commissioning and ongoing maintenance of hardware. This concept includes all matters relating to maintenance and support of the operating system and installed applications, particularly continuous updating to avoid security problems. Another set of content services are the CONNECTIVITY or Internet access, private connections (VPN) to facilitate the exploitation of data to customers, firewall protection and intrusion detection, backup, personalized monitoring of all components and applications, reports and usage statistics, events, consumer, accounting transactions, etc. These services are continuously available and supported by a 24×7 operations center. It offers clients access to certain partial service data and statistics via a control panel web service.

6.9—A Technical Maintenance and Operation Technical Support (see FIG. 5 p) in which the specific service Technical Maintenance includes all functions dedicated to the operation continued from system operations.

Includes a Call Center or Technical Assistance Center of incoming and outgoing calls. It is a tool of communication and relationship with users by phone and common use media, managed by administrative staff with the necessary degree of qualification. The activity of the technical operators is directed to manage a set of human, physical and technological resources available, based on methodologies and processes identified and appropriate to meet the needs and serve each user in order to maintain and sustain the trust and loyalty with the system and allow viability.

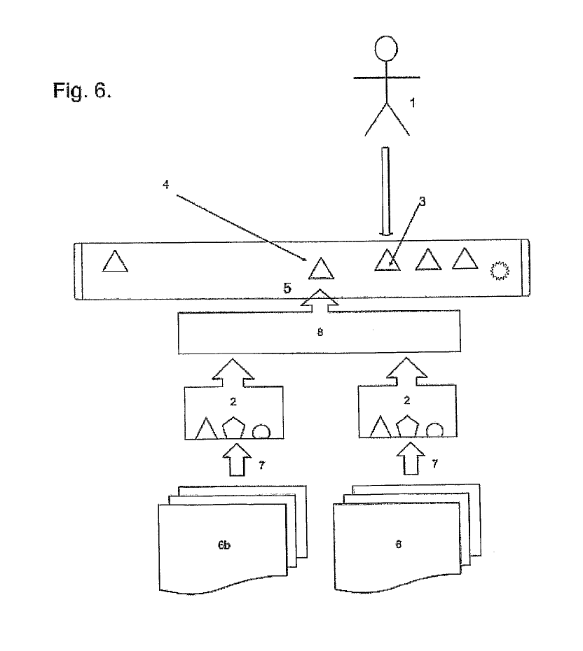

6.10 About monitoring and Management of proper Connectivity data from health information processes (see FIG. 6 pg). The service-specific monitoring and Management of proper Connectivity data from external health information systems is key to sustaining the basic function of integration of information from various sources with total transparency to the user.

The system establishes a “monitor channel” or flow test data with each provider of integrated medical data, that is, every health system that has a direct integration of management systems of clinical data with the system.

Additionally, it allows the establishment of a “self-monitoring channel” for data from the PROFESSIONAL proprietary system.

The data that is permanently checked are:
Operational status “open” channel.
Filtering of noninfringement.
Monitoring the correct expected volume of data over time.
Random Monitoring of anonymous patient data.

The system generates periodic reports an analysis with the magnitudes listed, for the continued verification of the operational management of the connecting channels. If the system detects any abnormality in the expected parameters for each channel, it launches an alarm designed to manage the impact both internally with the technical maintenance of the system and in communication with the source of origin of the affected channel data.

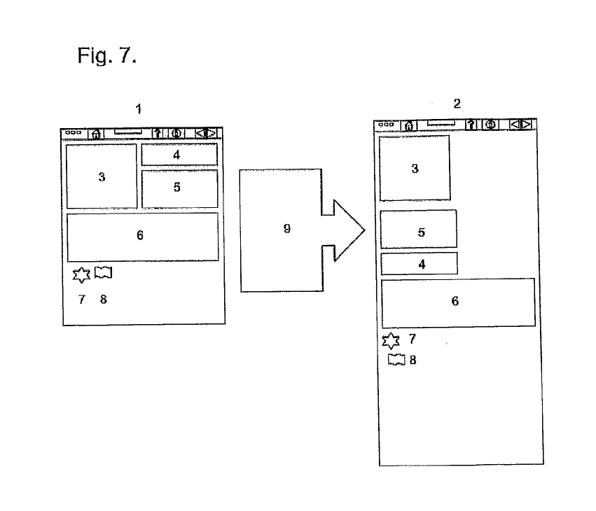

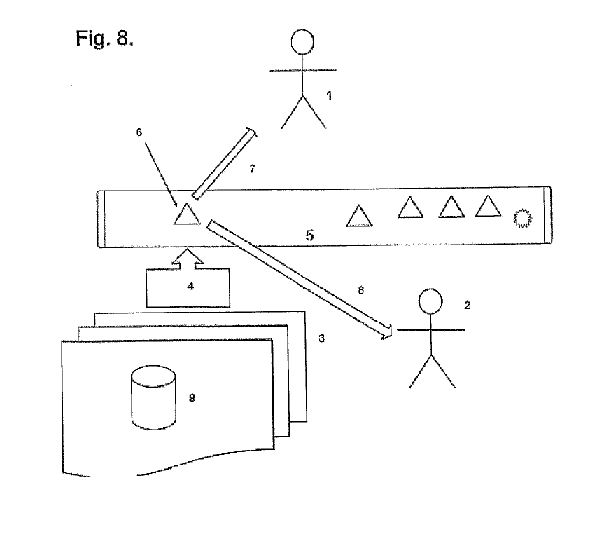

7.1—An scheduled phone anamnesis operation. (See FIG. 7 Page)

It is a process that allows an optimal deployment and implementation of basic data entry for a single user. Using a specific protocol, a licensed physician calls the user to lay the foundations of their clinical history in the storage mode. Previously, the administrative management mode is brought into contact with the user (which in turn has to have previously accepted and consented to the procedure). The operator decides the best schedule in connection with the user, in order to be called by one of the doctors from the “pool of doctors” of the system. One of these physicians performs the full interview, enters the data into the user's personal account, instructs the user on the future use of the system and sets the best monitoring protocol for use in continuity (see ANNEX 19). Structure of the interview system:
Greeting and start.—Length of 5 to 20 seconds.
Basic Data Communications (PPD) and establishment of empathy.—Duration 30 to 60 seconds.
Sociological Analysis and psychogram.—Duration 1 to 2 minutes.
Reason for interview: Initial reconstruction medical profile for the system. Duration of 20 seconds.
Profile exploration. Capture specific data for clinical onset, intensity, duration, frequency, association with events or situations.—Duration 3 to 6 minutes.

1.—Family history. Duration between 1 to 2 minutes.

2.—Personal history.—Duration 1 to 2 minutes.
Early childhood (O to 6 years).
Second Childhood (6 to 12 years).
Adolescents (12 to socio-economic independence).
Young adulthood (to age 40).
Mature adulthood (40 to 65-70 years).
Aging (over 70 years).

3. Explanation of findings to the patient.—Duration of 30 seconds.

9. Farewell and greeting.—Duration of 15 seconds.

Total minimum: 7.5 minutes

Total maximum: 14.5 minutes

Average duration: 11 minutes.

The times are indicative and not prescriptive, they can even vary from case.

7.2—A Proactive Recovery operation and Medical Reports Flow Monitoring operation. Information to prevent users about forgetting to enter relevant information in the PHR system.

Initially, the system proceeds to set the user type in a pattern that provides guidance on the expected probability of input.

Basically these groups are:
Users without remarkable pathologies.
Children
Adolescents.
Women of childbearing age.
Users with mild chronic pathology.
Users with moderate chronic pathology.
Users with severe chronic disease.
Users over 65 years.

And all possible combinations among these groups.

Each of these groups has an expected casuistry and a likely rate of input (from totally unexpected illnesses, accidents or random, to data in which the probability of incoming data is 100%, as vaccinations).

Administrative Control Center, following these guidelines and protocols the system contacts the doctor manager whom is placed in relation to the “medical pool” system. These physicians made regular calls (with a minimum of three months cadence) to establish three key follow-up actions:
Whether there has been an episode that has not been introduced into the database.
Helping the user to enter if you have been.
Strengthen prevention information and raise awareness of quality of care.

7.3—An operation to classify the Typology of Information, ICD coding, and the Classification of Types of Reports, that allows the user and the physicians to access a large volume of clinical information easily and at a glance. This information is created by the graphic subsystem “Types of Reports” and generates a “snapshot” of the user's medical profile of great value when taking into account risk factors or a major clinical history that can be of great importance in the life of the patient.

Basically, the classification comprises the following fields:
3-letter acronym: defines the type of report (LAB=Laboratory, RAX=Radiology X-Ray, MRI=magnetic resonance imaging).
Exact date.
Grouping episode.

It is important to note that the system not only provides rapid and orderly information on the main medical specialties that affect the user and the timing of events, but additionally groups the events in higher-level events (hospital admissions, for example). Doctors at the “pool of physicians' daily review system reports deposited in the database and are able to add data to the protocol described above. In cases where there are doubts about whether multiple events are isolated or not, or should be grouped into a higher clinical entity, the physicians contact the patient (by phone, email, etc.) to assist him to get supplemental information.

7.4—An operation of Medical Support Call Center for incidents, with introduction or extraction of information.

When receiving a call from a user, the Call Center operator discriminates whether it is a purely administrative problem, if it is a technical problem or if it is on health grounds. Health such incidents are those that deal with the management of health data on their interaction with the PHR, whether data of the Journal of Patient or problems related to the introduction of clinical reports on user account.

When the operator determines that it is a health problem, transfers the call to a Medical Manager, which in turn decides whether it is necessary to contact the user again (not necessarily by physicians, but for other types of health professionals).

7.5—An operation for system monitoring, CAC management, and troubleshooting in the flow of information between doctors and patients through the CAC system (Continuum Assisted Care). It is based on the rapid creation and easy manipulation of disease monitoring protocols. This is a private relationship between doctor and patient that is automated and simplified through the CAC platform.

The services are related to the CAC system support, to oversee and monitor the correct flow of information that may occur once the monitoring and control relationship between doctors and patients is established.

The order of performance is as follows:
Regular review of all protocols or templates that are activated in a given period of time.
Introduction of the monitoring system at intervals scheduled by the doctor.
Automatic check for compliance by the patient to the frequency indicated.
In cases in which detects absence of data reception the call center is brought into contact with the user as the first phase.
If the patient wishes to leave the monitoring, reporting to the doctor and the protocol is aborted.
In the case of an error or a problem of logistics, it supports the user and providing support to assist the delivery of information by the patient. Additionally, the doctor sends a report on the operation control system to facilitate data flow, informing that the delay is not an abandonment by the patient. In the latter case, the patient is reclassified to perform a more intense monitoring future.

In order to clarify details of the description below refers to the representation of sheets of drawings by way of illustration and not limitation are detailed:

In the drawings:

FIG. 1.—Is a representative diagram of the functional operation of data entry Security by fax.

FIG. 2 is a representative diagram of the functional operation of data entry via CONNECTIVITY.

FIG. 3 is a representative diagram of the functional operation of prevention profile.

FIG. 4 is a representative diagram of the functional operation 1. assisted care continuity (CAC) Part 1.

FIG. 5 is a representative diagram of the functional operation of the continuity assisted support (CAC) Part 2.

FIG. 6 is a representative diagram of the functional operation of system integration.

### PREFERRED EMBODIMENT OF THE INVENTION

The following describes a preferred embodiment of the invention in schematic version summarized in which:
Data Entry System via Secure Fax FIG. 1, comprising the user (1), the module “History” User Reports doctor or PHR own (2), the Secure Fax (3) (fixed+unique identifier number per user); other user reports from various sources (4) and central database (5).
Data Entry System connectivity via FIG. 2, comprising the user (1), a standard connector module for accepting and structured tabular data (2); Secure Fax (3) (fixed number and unique identifier for user), other reports of the user (1) from different origins (4), central database (5), hospital information system (HIS) and extraction process and specifies connection tabulated data.
Profiling prevention system comprising FIG. 3 user (1), group of data defining the type of user according to their pathology (2); proprietary system of selecting a profile tabulated according to the data set (3); process of assigning a pattern of prevention associated with a profile (4), central database (5), database and instructions on prevention process (6), selection of instructions for the prevention package (7) and delivery prevention package suitable to the specific user (8) (via web, SMS, etc.).
Continuum Assisted Care system (CAC) Part 1 comprising FIG. 4 user (1), physician (2), proprietary system for creating formularies for collecting patient data (3); conversion process to get a questionnaire form from a simple question/answer sheet, (4), central database (5), questionnaire assigned to a patient in the database (6) and delivery of the questionnaire to the final user (1) (via web, SMS, etc.) (7).
Continuum Assisted Care system (CAC) Part 1 comprising FIG. 4 user (1), physician (2), proprietary system for creating formularies for collecting patient data (3); conversion process to get a questionnaire form from a simple question/answer sheet, (4), central database (5), questionnaire assigned to a patient in the database (6) and delivery of the questionnaire to the final user (1) (via web, SMS, etc.) (7).
Process Integration System. FIG. 6 user comprising (1), standard connector for accepting and structured tabular data (2), secure fax (3) (fixed number+unique identifier per user); other user reports from different origins (4), central database (5), hospital information system (HIS) (6), Other different hospital information system (HIS (6b) connection process and specific extraction of tabular data (7) and approval process and standardization of data and information (8).

Having described the nature of the invention conveniently etc . . .

1. System comprising the following data entry:
1.1.—Via WEB.
1.2.—Secure Fax.
1.3.—Via connectivity.

2. System comprising the following operations:
2.0—Proprietary system for health history representation and information gathering via the Web:
2.1—full report.
2.2—specific extraction of information.
2.3—descriptive interface of the report.

3. System comprising the following operation for the health journal:
3.1—Summary screen.
3.2—Main screen.

4. A system comprising the following operation for prevention:
4.1—general.
4.2—profile based.

5. System comprising the following operations:
5.1—emergency PIN-based information extraction;
5.2—Continuum Assisted Care system (CAC) (1), (2), (3) and (4).

6. System comprising the following operations:
6.1—process integration.
6.2—adaptive, embedded and mimicry.
6.3—about professionals (1), (2) and (3)
6.7—CAC Web to schedule protocols.
6.8—Web hosting and connectivity.
6.9—on the maintenance and technology support.
6.10—of monitoring and management of proper connectivity to data from health information systems.

7. System comprising the following operations:
7.1—about structured phone anamnesis.
7.2—proactive recovery and medical records flow monitoring.
7.3—type classification and ICD coding reporting.
7.4—about the call center for medical support to incidents with the introduction or extraction of information.
7.5—about system monitoring and management of CAC and troubleshooting in the flow of information between doctors and patients.

2. System . . . according to claim 1, which consists of data entry via Web and is characterized by allowing access to a form to select a file to be added to your particular database in the following formats:
JPEG.
GIF.
TIFF.
BMP.
PDF;
and additionally allows you to enter certain information associated with the document that is downloaded to the server:
Date of report.
Physician/author.
Specialty.
Center of Origin.
Report type.
all this information will be classified within the database system as unverified.

3. System . . . according to claim 1, which consists in introducing secure fax data which is characterized in that the user has a unique identification code and a unique private fax number composed of 9 initials of the header numbers plus individual code assigned.

4. System . . . according to claim 1, which consists in introducing path connectivity data which is characterized by having connecting links or direct connectivity to the system, storing a copy directly on the central database system.

5. System . . . according to claim 1, which consists in verifying the owner of the historic representation of health CHARACTERIZED because it allows to have a quick and accurate picture of his medical profile with a single view at a glance and a diagram showing a time scale axis and another axis columns that symbolize the different medical areas that divide medical specialties and comprising the following elements:
3-letter-acronym: defines the type of report (LAB=Laboratory, RAX=Radiology X-Ray, MRI=magnetic resonance imaging).
Exact date, and
Additionally, if an operation the following reports:
Emergency report.
Lab Report.
Preanesthetic preparation report.
Surgery report.
Treatment continuity report.
Discharge Report.

6. System . . . according to claim 1, which involves the extraction of information via the Web—with an specific extraction interface and route description of the full report which is characterized because it consists of two options:
A: Capturing the full report.
B: Specific capture and and report search.
The user has an interface that allows to select:
Range of insertion dates for the search (start/end).
Range of creation dates for the search (start/end).
Medical specialities.
Center of Origin.
Type of report.
Medical/Editor of the Report.
ICD code.
also allows
Encoded information.
Text of the report.
Pictures or attachments.

7. System . . . according to claim 1, which consists of the daily health check-summary screen that comprises a double option characterized in that it comprises:
Summary screen.—Allows the user from the home page of global information gathering your data, go to:
Personal health summary system. Expresses the overall quality of life for users and presents a detailed explanation based on data from the same over time. In turn windows are disclosed in specific for:
Weight control.
Control Habits of Healthy Living.
Control Diet.
Control of Exercise.
Personal calendar. Allows user to set appointments and reminders on the dates you want. These quotes can be associated alarms are sent to you via email or the mobile phone with SMS gateway technology.
Home Screen. Provides access to more accurate and tracking tables for each of the basic parameters. It also contains a form where the user can update, with the frequency he desires, the basic data about personal health status.

8. System . . . according to claim 1, comprising a general prevention operation characterized in that it involves processes which report on any published prevention protocol, which information does not leak but as it is reached by the source or source; performing updating and renewal of those with constant seasonal change, shown in two areas:
Summary window in the custom page of the user.
Detailed explanation windows (higher or lower depending on the content of the protocol in question).

9. System . . . according to claim 1, consisting of a profile prevention operation by which these are processes which report on any protocol that is released preventing characterized in that in this case the information is filtered and intersects with the data that the system contains primarily with those for:
Age.
Sex.
Weight.
Smoking-habits.
Drug-habits.
Stress.
Dietary habits.
Personal History.
Family History.
With these premises, an additional prevention can be done with a high degree of sophistication and specificity, oriented such that user need not to go to the doctor's office to find out if he should be included in certain risk groups.
The operation also includes:
A summary screen which shows the results of cross-checking with database of all potential prevention protocols for all risk groups.
A specific discussion screen of each particular protocol with the possibility of a personalized and self-control

10. System . . . according to claim 1, comprising an operation consisting of Information Extraction via EMERGENCY PIN. All users, when registering in the system, also receive along with the name and password, a special number called EMERGENCY PIN. By using this Pin (either through the process described by web or by phone), the user obtains immediately the complete medical file contained in the system, sent to the desired address (email, fax, or print directly via the web).

11. System . . . according to claim 1, comprising an operation that consists in verifying the CONTINUUM ASSISTED CARE (CAC) (1) in which the owner of the system to process CONTINUUM ASSISTED CARE (CAC) has 2 major components:
A) The individualized pattern operation via web (for doctors). It is a secure web-accessible way that allows the physician to select a specific patient and establish a simple custom protocol. In addition to setting the parameters to be controlled, can make both the frequency and mode of delivery and collection. The fields that the system provides are:
A) Name of the protocol (can be saved commonly used protocols or standard):
B) Name of the parameter.
C) Maximum value evaluable.
D) Minimum evaluable.
E) monitoring mode (receive mode of information).
F) common monitoring option.
B) The patient review system, both as detailed or aggregated review of patient data.
Medical users can access a web system that allows:
A) Check with an overview of health status, trends and observations of patients in follow-up.
B) Review in depth the evolution of part of a particular patient.

12. System . . . according to claim 1, comprising an operation of systems integration (see block diagram in FIG. 4 p) comprises the development of the operational elements that allow the integration of patient's data with any HIS (Hospital Information System), Primary Care Systems, or Clinical Record Management Systems for Clinics or other medical centers.
The product contains a precise definition of the fields to import:
Name of the Report.
Id. Patient.
Name of Patient.
Basic Personal details of the patient.
Deliverable text report.
Added files (images, etc.).
ICD code.
Internal classification and indexing code.
Medical Specialty.
Date.
Type.
Index of opening or closing episode.
Furthermore, we have developed APIs (Application Programming Interfaces) that allow basic communications of other processes fluently with the system. The system provides a complete set for the communication of the fields described above as well as a general definition for future development.

13. System . . . according to claim 1, comprising an operation of ADAPTATION, EMBEDDED and mimicry that allows the system, which evolved into interchangeable blocks of code and XML templates, for easy integration into Web sites of other institutions.
Furthermore, these templates allow rapid changes in:
Color scheme.
Outline of topics.
Font sizes and types of headers.
Relational placement schemes.
The functionality of the system can be used in a different environment, providing brand image to a separate company, but using the “engine” and operating the same database system all completely transparent to the end user.

14. System . . . according to claim 1, comprising a global professional operation characterized in that the application consists of pictures or frames and menus, and provides information such that:
General information:
Name of the application and the entity it is connected to the system.
Type of profile for the user.
Application menus. There are three menus:
1—File menu. Has the options to save, change general information, change password, drug database and exit.
Save submenu lets you record any changes.
The general data change submenu allows you to modify the general data of the user. May change the name, surname, number of collegiate and email.
The Change Password submenu allows us to modify our password to the application.
The drug database submenu, leads to the publications page from where you access the consultation of drugs and active ingredients thereof.
The exit submenu is used to exit the application.
2—Tools Menu submenu contains tools to edit preferences and body care:
Preferences submenu offers access to configure features of the particular application:
Location of the drug database or access a free version.
Configuration data transmission allows data or parameters configure the mail server and account.
Language: select the language that presents the texts and messages of the application.
The edit submenu allows access health entity to modify data in the daily clinical activity: name, description, and add or remove works with insurance clinic.
3—Help menu, where the user can see the technical information of the application.

15- System . . . according to claim 1, comprising a CAC web operation protocols to schedule individualized profile activity via web, characterized in that it allows for a simple accessible secure web protocol that lets you select a specific patient and establish a simple custom guideline consisting of the fields:
A) Name of the parameter.
B) Maximum value evaluable.
C) Minimum evaluable.
D) monitoring mode (receive mode of information).
E) common monitoring option.

16- System . . . according to claim 1, consisting of a transaction monitoring and management of proper connectivity data from from health information processes characterized in that the specific service establishes a “monitoring channel” or test data stream with each data provider, that is, with every health system that has a direct integration of management systems of clinical data with the system, further establishing a “self-monitoring channel” for data from the PROFESSIONAL proprietary system:
Operational status “open” channel.
Filtering of noninfringement.
Monitoring the correct expected volume of data over time.
Random Monitoring of anonymous patient data.

17- System . . . according to claim 1, comprising a patterned telephone operation characterized in that it allows an optimum deployment and operation of a user PHR (Personal Health Record system) through a specific protocol apparatus and a general protocol, setting the best monitoring protocol to be used in the continuity and that initially, proceed to set he type of user among basically:
Users without remarkable pathologies.
Children
Adolescents.
Women of childbearing age.
Users with mild chronic pathology.
Users with moderate chronic pathology.
Users with severe chronic disease.
Users over 65 years.
And all possible combinations among these groups and, following these guidelines and pre-established protocols of the process:
Whether there has been an episode that has not been introduced.
Helping the user to enter if that is the case.

18- System . . . according to claim 1, comprising an operation to classify the typology of information, ICD coding, and the classification of types of reports, that allows the user and the physicians to access a large volume of clinical information easily and at a glance. Basically, the classification comprises the following fields:
3-letter acronym: defines the type of report (LAB=Laboratory, RAX=Radiology X-Ray, MRI=magnetic resonance imaging).
Exact date.
Grouping episode.
